(19) United States
(12) Patent Application Publication
(10) Pub. No.: US 2023/0131833 A1
(43) Pub. Date: Apr. 27, 2023

(54) Communication Method and Terminal Device

(71) Applicant: Huawei Technologies Co., Ltd., Shenzhen (CN)

(72) Inventor: Yong Li, Shanghai (CN)

(21) Appl. No.: 17/911,862

(22) PCT Filed: Mar. 9, 2021
(86) PCT No.: PCT/CN2021/079657

§ 371 Date: Sep. 15, 2022

(30) Foreign Application Priority Data
Mar. 16, 2020 (CN) 202010181562.6

(51) Int. Cl. H04W 76/18; H04W 60/06

(52) U.S. Cl. CPC H04W 76/18; H04W 60/06

(57) ABSTRACT

A communication method includes a terminal device that sends a user plane resource establishment request message to a network device, and receives a feedback message from the network device for the user plane resource establishment request message, where the feedback message includes a cause value of a user plane resource establishment failure. The terminal device performs, based on the cause value, an operation corresponding to the cause value. Different cause values may correspond to different operations. In this way, a communication link between the terminal device and the network device is established. In addition, in a scenario with a poor communication condition, the terminal device may deregister from a currently registered network, and register with another network.

This application claims priority to Chinese Patent Application No. 202010181562.6, filed with the China National Intellectual Property Administration on Mar. 16, 2020 and entitled “COMMUNICATION METHOD AND TERMINAL DEVICE”, which is incorporated herein by reference in its entirety.

### TECHNICAL FIELD

This application relates to the communications field, and more specifically, to a communication method and a terminal device.

### BACKGROUND

Before a terminal device transmits data with a network device, the terminal device may send a network registration request message to the network device, to access a mobile communications network. Then, the terminal device may send a session establishment request message to the network device. The network device may establish a session for the terminal device based on the session establishment request message sent by the terminal device, and configure a user plane resource for the terminal device. Then, the terminal device may receive, on the user plane resource configured by the network device, downlink data sent by the network device, and the terminal device may send uplink data to the network device on the user plane resource configured by the network device. In this case, a communication link between the terminal device and the network device is established.

If the communication link between the terminal device and the network device fails, the terminal device cannot receive data sent by the network device, and the network device cannot receive data sent by the terminal device. The failure of the communication link is unfavorable for the terminal device to obtain information in a timely manner, and is unfavorable for the terminal device to feed back a message for obtained information in a timely manner. There are a plurality of causes of the failure of the communication link between the terminal device and the network device. It is difficult for the terminal device to find, in a relatively short time, a cause of the communication link failure, and it is also difficult to recover the communication link between the terminal device and the network device in a timely manner. Therefore, a solution needs to be provided to recover the communication link between the terminal device and the network device as soon as possible.

### SUMMARY

This application provides a communication method and a terminal device, to recover a communication link between a terminal device and a network device as soon as possible, so as to recover data transmission as soon as possible.

According to a first aspect, a communication method is provided, including: A terminal device sends a user plane resource establishment request message to a network device; the terminal device receives a feedback message sent by the network device for the user plane resource establishment request message, where the feedback message includes a cause value of a user plane resource establishment failure; and when the cause value is a first cause value, the terminal device performs a first operation; or when the cause value is a second cause value, the terminal device performs a second operation, where the first cause value is different from the second cause value, the first operation is different from the second operation, and both the first operation and the second operation include an operation for establishing a communication link between the terminal device and the network device.

Optionally, for example, the cause value may be a cause value included in the standard document 3gpp 24501-g10 in 5G mobility management (5th generation system mobility management, 5GMM).

Optionally, the cause value may include, for example, a cause value #22, a cause value #28, a cause value #43, a cause value #65, a cause value #67, a cause value #69, a cause value #73, a cause value #90, a cause value #91, a cause value #92, a cause value #95, a cause value #96, a cause value #97, a cause value #98, a cause value #99, a cause value #100, a cause value #101, or a cause value #111.

In this application, the terminal device may quickly determine, based on the cause value sent by the network device, whether the communication link fails. In addition, the cause value may reflect a status of the communication link between the terminal device and the network device. The terminal device may take a relatively targeted measure (that is, a measure corresponding to the cause value) based on the cause value, and skip an unnecessary step, so that the communication link between the terminal device and the network device can be recovered relatively quickly. This helps improve efficiency of recovering the communication link.

With reference to the first aspect, in some implementations of the first aspect, the operation for establishing a communication link between the terminal device and the network device includes at least one of the following: updating a route configuration; re-sending the user plane resource establishment request message to the network device; releasing a session resource and sending a session establishment request message to the network device; sending a first deregistration request message to the network device, and sending a first registration request message for a first communications network to the network device, where the first deregistration request message is used to cancel registration with the first communications network, and the first registration request message is used to establish the communication link by using the first communications network; enabling an offline mode and disabling the offline mode; and sending a second deregistration request message to the network device, and sending a second registration request message for a second communications network to the network device, where the second deregistration request message is used to cancel registration with a used third communications network, and the second registration request message is used to establish the communication link by using the second communications network.

Updating the route configuration may refer to reading routing information from a memory and updating the route configuration based on the routing information.

Re-sending the user plane resource establishment request message to the network device may refer to re-configuring a user plane resource.

Releasing the session resource and sending the session establishment request message to the network device may refer to a process of re-establishing a session.

Sending the first deregistration request message and the first registration request message may refer to re-registering with the first communications network.

Enabling the offline mode and disabling the offline mode may refer to restarting a mobile communications module.

Sending the second deregistration request message and the second registration request message may refer to switching a communications network.

The first communications network may be, for example, a 5G communications network, an NR communications network, or a 6G communications network.

The second communications network may be, for example, a GSM communications network, a UMTS communications network, or an LTE communications network.

The third communications network may be, for example, a 5G communications network, an NR communications network, or a 6G communications network.

Optionally, the third communications network is a preferred communications network of the terminal device, and the second communications network is a second preferred communications network of the terminal device.

In this application, an effect of quick link recovery may be achieved by using the foregoing effective link recovery method.

With reference to the first aspect, in some implementations of the first aspect, the sending a second deregistration request message to the network device, and sending a second registration request message for a second communications network to the network device further includes: setting a timer, where the timer is used to time a process of using the second communications network; and when the timer reaches a preset threshold, sending a third deregistration request message to the network device, and sending a third registration request message for the third communications network to the network device, where the third deregistration request message is used to cancel registration with the second communications network, and the third registration request message is used to establish the communication link by using the third communications network.

In this application, the terminal device usually chooses to attach to the preferred communications network. When the preferred communications network is faulty, the terminal device may switch to the second preferred communications network. By setting the timer, the terminal device can switch from the second preferred communications network to the preferred communications network in a timely manner, so that relatively good user experience can be achieved.

With reference to the first aspect, in some implementations of the first aspect, before the timer reaches the preset threshold, the sending a second deregistration request message to the network device, and sending a second registration request message for a second communications network to the network device further includes: displaying an identifier of the second communications network; and after the sending a third registration request message for the third communications network to the network device, the sending a second deregistration request message to the network device, and sending a second registration request message for a second communications network to the network device further includes: displaying an identifier of the third communications network.

In this application, an identifier of a communications network is displayed, so that a user can perceive that the communications network is switched. This can achieve relatively good user experience.

With reference to the first aspect, in some implementations of the first aspect, the sending a second deregistration request message to the network device, and sending a second registration request message for a second communications network to the network device further includes: sending indication information to the network device, where the indication information is used to indicate that the terminal device does not support the third communications network.

In this application, that the terminal device does not support the third communications network may refer to that the terminal device does not send or receive a message by using the third communications network. After receiving the indication information, the network device may not send a message to the terminal device by using the third communications network within a period of time, and allocate a resource of the third communications network that is originally allocated to the terminal device to another terminal device. Therefore, a signaling loss can be reduced, and signaling receiving and sending efficiency can be improved.

With reference to the first aspect, in some implementations of the first aspect, the first operation includes K sub-operations, the K sub-operations are in a one-to-one correspondence with K priorities, and that the terminal device performs the first operation includes: The terminal device performs the K sub-operations based on the K priorities.

In this application, the terminal device may sequentially perform, based on the priorities of the sub-operations, operations for establishing the communication link between the terminal device and the network device. The terminal device may preferably perform a step with a relatively high success rate. This helps improve efficiency of recovering the communication link.

With reference to the first aspect, in some implementations of the first aspect, the first operation includes cyclically performing a target sub-operation M times, the second operation includes cyclically performing the target sub-operation N times, both M and N are positive integers, and M is not equal to N.

In this application, the cause value may reflect a status of the communication link between the terminal device and the network device. Therefore, the terminal device may determine, based on the cause value, a quantity of times of cyclically performing a step. This can simplify steps of recovering the communication link.

With reference to the first aspect, in some implementations of the first aspect, the first cause value belongs to a first cause value type, the second cause value belongs to a second cause value type, the first cause value type includes one or more of a cause value #65, a cause value #67, a cause value #69, and a cause value #92, and the second cause value type includes one or more of a cause value #95, a cause value #96, a cause value #97, a cause value #100, and a cause value #101. That the terminal device performs the first operation when the cause value is the first cause value includes: The terminal device performs the first operation when the cause value belongs to the first cause value type; or that the terminal device performs the second operation when the cause value is the second cause value includes: The terminal device performs the second operation when the cause value belongs to the second cause value type.

In this application, the cause values are classified, and a same cause value is enabled to indicate different meanings in different scenarios. The terminal device performs a corresponding operation based on a type corresponding to the cause value, so that the operation can be more specific.

According to a second aspect, a communication method is provided, including: A terminal device determines that a communication link between the terminal device and a network device fails; the terminal device updates a route configuration; when the communication link still fails, the terminal device releases a session resource and sends a session establishment request message to the network device; when the communication link still fails, the terminal device sends a first deregistration request message to the network device, and sends a first registration request message for a first communications network to the network device, where the first deregistration request message is used to cancel registration with the first communications network, and the first registration request message is used to establish the communication link by using the first communications network; and when the communication link still fails, the terminal device sends a second deregistration request message to the network device, and sends a second registration request message for a second communications network to the network device, where the second deregistration request message is used to cancel registration with the first communications network, and the second registration request message is used to establish the communication link by using the second communications network.

Optionally, the first communications network is a preferred communications network of the terminal device, and the second communications network is a second preferred communications network of the terminal device.

In this application, the terminal device chooses to attach to another communications network, so that the communication link between the terminal device and the network device can be quickly recovered.

With reference to the second aspect, in some implementations of the second aspect, the communication method further includes: The terminal device sets a timer, where the timer is used to time a process of using the second communications network, and when the timer reaches a preset threshold, the terminal device sends a third deregistration request message to the network device, and sends a third registration request message for the first communications network to the network device, where the third deregistration request message is used to cancel registration with the second communications network, and the third registration request message is used to establish the communication link by using the first communications network.

In this application, the terminal device usually chooses to attach to the preferred communications network. When the preferred communications network is faulty, the terminal device may switch to the second preferred communications network. By setting the timer, the terminal device can switch from the second preferred communications network to the preferred communications network in a timely manner, so that relatively good user experience can be achieved.

With reference to the second aspect, in some implementations of the second aspect, before the timer reaches the preset threshold, the communication method further includes: The terminal device displays an identifier of the second communications network. After the terminal device sends the third registration request message for the first communications network to the network device, the communication method further includes: The terminal device displays an identifier of the first communications network.

In this application, an identifier of a communications network is displayed, so that a user can perceive that the communications network is switched. This can achieve relatively good user experience.

With reference to the second aspect, in some implementations of the second aspect, the communication method further includes: The terminal device sends indication information to the network device, where the indication information is used to indicate that the terminal device does not support the first communications network.

In this application, that the terminal device does not support the first communications network may refer to that the terminal device does not send or receive a message by using the first communications network. After receiving the indication information, the network device may not send a message to the terminal device by using the first communications network within a period of time, and allocate a resource of the first communications network that is originally allocated to the terminal device to another terminal device. Therefore, a signaling loss can be reduced, and signaling receiving and sending efficiency can be improved.

With reference to the second aspect, in some implementations of the second aspect, before the terminal device releases the session resource, when the communication link still fails, the communication method further includes: The terminal device sends a user plane resource establishment request message to the network device.

In this application, compared with re-establishing a session, re-configuring a user plane resource takes a relatively short time. If re-configuring the user plane resource can effectively resolve a communication link failure, a process of recovering the communication link can be relatively quick and effective.

With reference to the second aspect, in some implementations of the second aspect, before the terminal device sends the second deregistration request message to the network device, when the communication link still fails, the communication method further includes: The terminal device enables an offline mode and disables the offline mode.

In this application, the terminal device automatically switches a communications mode to the offline mode, and then automatically switches the communications mode out of the offline mode, so that a mobile communications module of the terminal device can be restarted. In this way, a relatively severe communication link failure can be rectified relatively quickly.

According to a third aspect, a terminal device is provided, including: a sending module, configured to send a user plane resource establishment request message to a network device; a receiving module, configured to receive a feedback message sent by the network device for the user plane resource establishment request message, where the feedback message includes a cause value of a user plane resource establishment failure; and a processing module, configured to perform a first operation when the cause value is a first cause value. The processing module is alternatively configured to perform a second operation when the cause value is a second cause value, where the first cause value is different from the second cause value, the first operation is different from the second operation, and both the first operation and the second operation include an operation for establishing a communication link between the terminal device and the network device.

With reference to the third aspect, in some implementations of the third aspect, the operation for establishing a communication link between the terminal device and the network device includes at least one of the following: updating a route configuration; re-sending the user plane resource establishment request message to the network device; releasing a session resource and sending a session establishment request message to the network device; sending a first deregistration request message to the network device, and sending a first registration request message for a first communications network to the network device, where the first deregistration request message is used to cancel registration with the first communications network, and the first registration request message is used to establish the communication link by using the first communications network; enabling an offline mode and disabling the offline mode; and sending a second deregistration request message to the network device, and sending a second registration request message for a second communications network to the network device, where the second deregistration request message is used to cancel registration with a used third communications network, and the second registration request message is used to establish the communication link by using the second communications network.

With reference to the third aspect, in some implementations of the third aspect, the sending a second deregistration request message to the network device, and sending a second registration request message for a second communications network to the network device further includes: setting a timer, where the timer is used to time a process of using the second communications network; and when the timer reaches a preset threshold, sending a third deregistration request message to the network device, and sending a third registration request message for the third communications network to the network device, where the third deregistration request message is used to cancel registration with the second communications network, and the third registration request message is used to establish the communication link by using the third communications network.

With reference to the third aspect, in some implementations of the third aspect, before the timer reaches the preset threshold, the sending a second deregistration request message to the network device, and sending a second registration request message for a second communications network to the network device further includes: displaying an identifier of the second communications network; and after the sending a third registration request message for the third communications network to the network device, the sending a second deregistration request message to the network device, and sending a second registration request message for a second communications network to the network device further includes: displaying an identifier of the third communications network.

With reference to the third aspect, in some implementations of the third aspect, the sending a second deregistration request message to the network device, and sending a second registration request message for a second communications network to the network device further includes: sending indication information to the network device, where the indication information is used to indicate that the terminal device does not support the third communications network.

With reference to the third aspect, in some implementations of the third aspect, the first operation includes K sub-operations, the K sub-operations are in a one-to-one correspondence with K priorities, and the processing module is specifically configured to perform the K sub-operations based on the K priorities.

With reference to the third aspect, in some implementations of the third aspect, the first operation includes cyclically performing a target sub-operation M times, the second operation includes cyclically performing the target sub-operation N times, both M and N are positive integers, and M is not equal to N.

With reference to the third aspect, in some implementations of the third aspect, the first cause value belongs to a first cause value type, the second cause value belongs to a second cause value type, the first cause value type includes one or more of a cause value #65, a cause value #67, a cause value #69, and a cause value #92, and the second cause value type includes one or more of a cause value #95, a cause value #96, a cause value #97, a cause value #100, and a cause value #101. The processing module is specifically configured to perform the first operation when the cause value belongs to the first cause value type; or the processing module is specifically configured to perform the second operation when the cause value belongs to the second cause value type.

According to a fourth aspect, a terminal device is provided, including: a processing module, configured to determine that a communication link between the terminal device and a network device fails, where the processing module is further configured to update a route configuration; and a sending module, configured to: when the communication link still fails, release a session resource and send a session establishment request message to the network device. The sending module is further configured to: when the communication link still fails, send a first deregistration request message to the network device, and send a first registration request message for a first communications network to the network device, where the first deregistration request message is used to cancel registration with the first communications network, and the first registration request message is used to establish the communication link by using the first communications network. The sending module is further configured to: when the communication link still fails, send a second deregistration request message to the network device, and send a second registration request message for a second communications network to the network device, where the second deregistration request message is used to cancel registration with the first communications network, and the second registration request message is used to establish the communication link by using the second communications network.

With reference to the fourth aspect, in some implementations of the fourth aspect, the processing module is further configured to set a timer, where the timer is used to time a process of using the second communications network; and the sending module is further configured to: when the timer reaches a preset threshold, send a third deregistration request message to the network device, and send a third registration request message for the first communications network to the network device, where the third deregistration request message is used to cancel registration with the second communications network, and the third registration request message is used to establish the communication link by using the first communications network.

With reference to the fourth aspect, in some implementations of the fourth aspect, the processing module is further configured to: before the timer reaches the preset threshold, display an identifier of the second communications network; and the processing module is further configured to: after the sending module sends the third registration request message for the first communications network to the network device, display an identifier of the first communications network.

With reference to the fourth aspect, in some implementations of the fourth aspect, the sending module is further configured to send indication information to the network device, where the indication information is used to indicate that the terminal device does not support the first communications network.

With reference to the fourth aspect, in some implementations of the fourth aspect, the sending module is further configured to: before the sending module releases the session resource, when the communication link still fails, send a user plane resource establishment request message to the network device.

With reference to the fourth aspect, in some implementations of the fourth aspect, the processing module is further configured to: before the sending module sends the second deregistration request message to the network device, when the communication link still fails, enable an offline mode and disable the offline mode.

According to a fifth aspect, a terminal device is provided, including modules configured to perform any possible implementation of the first aspect and the second aspect.

According to a sixth aspect, a computer program storage medium is provided. The computer-readable medium stores program code, and when the computer program code is run on a computer, the computer is enabled to execute instructions of any possible implementation of the first aspect and the second aspect.

According to a seventh aspect, a computer program product including instructions is provided. When the computer program product is run on a computer, the computer is enabled to perform the method in any one of the possible implementations of the first aspect and the second aspect.

According to an eighth aspect, a communication apparatus is provided, and is configured to perform the method in any one of the possible implementations of the first aspect and the second aspect.

According to a ninth aspect, a communication apparatus is provided. The apparatus includes a processor and a memory. The processor is coupled to the memory, the memory is configured to store a computer program, and the processor is configured to execute the computer program stored in the memory, so that the communication apparatus performs the method in any one of the possible implementations of the first aspect and the second aspect.

According to a tenth aspect, a communication apparatus is provided. The apparatus includes a processor, a memory, and a transceiver. The memory is configured to store a computer program, and the processor is configured to execute the computer program stored in the memory, so that the apparatus performs the method in any one of the possible implementations of the first aspect and the second aspect.

According to an eleventh aspect, a communication apparatus is provided. The communication apparatus includes at least one processor and a communication interface. The communication interface is used by the communication apparatus to exchange information with another communication apparatus, and when program instructions are executed by the at least one processor, the communication apparatus is enabled to implement the method in any one of the possible implementations of the first aspect and the second aspect.

According to a twelfth aspect, a processor is provided. The processor includes at least one circuit, configured to perform the method in any one of the possible implementations of the first aspect and the second aspect.

According to a thirteenth aspect, a chip system is provided. The chip system includes at least one processor, and when program instructions are executed by the at least one processor, the chip system is enabled to implement the method in any one of the possible implementations of the first aspect and the second aspect.

### BRIEF DESCRIPTION OF DRAWINGS

FIG. 1 is a schematic diagram of a communication scenario according to an embodiment of this application;

FIG. 2 is a schematic flowchart of a communication link recovery method;

FIG. 3 is a schematic diagram of a structure of a communication link recovery mechanism:

FIG. 4 is a schematic flowchart of a communication link recovery method;

FIG. 5 is a schematic flowchart of a communication method according to an embodiment of this application;

FIG. 6(a) and FIG. 6(b) are a schematic diagram of a user interface of a communication method according to an embodiment of this application;

FIG. 7 is a schematic flowchart of a communication link recovery method according to an embodiment of this application;

FIG. 8 is a schematic flowchart of a communication method according to an embodiment of this application;

FIG. 9 is a schematic diagram of a structure of a communication apparatus according to an embodiment of this application;

FIG. 10 is a schematic diagram of a structure of a communication apparatus according to an embodiment of this application; and

FIG. 11 is a schematic diagram of a structure of a communication apparatus according to an embodiment of this application.

### DESCRIPTION OF EMBODIMENTS

The following describes the technical solutions of this application with reference to the accompanying drawings.

The technical solutions in embodiments of this application may be applied to various communication systems, such as a global system for mobile communications (global system for mobile communications, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an LTE frequency division duplex (frequency division duplex, FDD) system, an LTE time division duplex (time division duplex. TDD) system, a universal mobile telecommunications system (universal mobile telecommunication system, UMTS), a worldwide interoperability for microwave access (worldwide interoperability for microwave access, WiMAX) communication system, a 5th generation (5th generation, 5G) system a new radio (new radio, NR) system or another communication system. The technical solutions in embodiments of this application may be further applied to a communication system later than the 5G system (for example, a future 6th generation (6th generation, 6G) system).

A terminal device in embodiments of this application may refer to user equipment, an access terminal, a subscriber unit, a subscriber station, a mobile station, a remote station, a remote terminal, a mobile device, a user terminal, a terminal, a wireless communication device, a user agent, a user apparatus, or the like. The terminal device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device, another processing device connected to a wireless modem, a vehicle-mounted device, a wearable device, a terminal device in a future 5G network, a terminal device in a future evolved public land mobile network (public land mobile network, PLMN), or the like. This is not limited in embodiments of this application.

A network device in embodiments of this application may be a device configured to communicate with the terminal device. The network device may be a base transceiver station (base transceiver station. BTS) in the global system for mobile communications (global system for mobile communications. GSM) or the code division multiple access (code division multiple access, CDMA) system, or may be a NodeB (NodeB, NB) in the wideband code division multiple access (wideband code division multiple access, WCDMA) system, or may be an evolved NodeB (evolved NodeB, eNB or eNodeB) in the LTE system, or may be a radio controller in a cloud radio access network (cloud radio access network, CRAN) scenario. Alternatively, the network device may be a relay node, an access point, a vehicle-mounted device, a wearable device, a network device in the future 5G network, a network device in the future evolved PLMN, or the like. This is not limited in embodiments of this application.

In embodiments of this application, the terminal device or the network device includes a hardware layer, an operating system layer running above the hardware layer, and an application layer running above the operating system layer. The hardware layer includes hardware such as a central processing unit (central processing unit, CPU), a memory management unit (memory management unit, MMU), and a memory (also referred to as a main memory). The operating system may be any one or more types of computer operating systems that implement service processing through a process (process), for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not particularly limited in embodiments of this application, provided that a program that records code of the method provided in embodiments of this application can be run to perform communication according to the method provided in embodiments of this application. For example, the execution body of the method provided in embodiments of this application may be the terminal device or the network device, or a functional module that can invoke and execute the program in the terminal device or the network device.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, a computer-readable medium may include, but is not limited to, a magnetic storage component (for example, a hard disk, a floppy disk, or a magnetic tape), an optical disc (for example, a compact disc (compact disc, CD) or a digital versatile disc (digital versatile disc, DVD)), a smart card, and a flash memory component (for example, an erasable programmable read-only memory (erasable programmable read-only memory, EPROM), a card, a stick, or a key driver). In addition, various storage media described in this specification may represent one or more devices and/or other machine-readable media that are configured to store information. The term “machine-readable medium” may include but is not limited to a wireless channel, and various other media that can store, contain, and/or carry instructions and/or data.

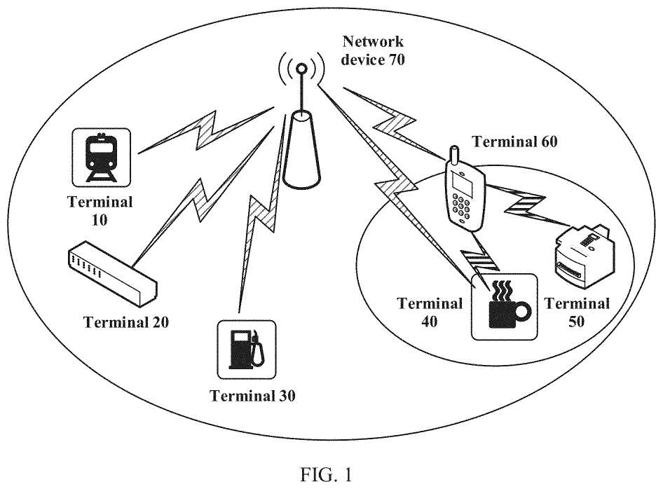

FIG. 1 is a schematic diagram of a communication system according to this application. The communication system in FIG. 1 may include at least one terminal (for example, a terminal 10, a terminal 20, a terminal 30, a terminal 40, a terminal 50, and a terminal 60) and a network device 70. The network device 70 is configured to provide a communication service for the terminal and access a core network. The terminal may access a network by searching for a synchronization signal, a broadcast signal, or the like sent by the network device 70, to communicate with the network. The terminal 10, the terminal 20, the terminal 30, the terminal 40, and the terminal 60 in FIG. 1 may perform uplink and downlink transmission with the network device 70. For example, the network device 70 may send downlink signals to the terminal 10, the terminal 20, the terminal 30, the terminal 40, and the terminal 60, and may receive uplink signals sent by the terminal 10, the terminal 20, the terminal 30, the terminal 40, and the terminal 60.

In addition, the terminal 40, the terminal 50, and the terminal 60 may also be considered as a communication system. The terminal 60 may send downlink signals to the terminal 40 and the terminal 50, and may receive uplink signals sent by the terminal 40 and the terminal 50.

It should be noted that embodiments of this application may be applied to a communication system including one or more network devices, or may be applied to a communication system including one or more terminals. This is not limited in this application.

It should be understood that the communication system may include one or more network devices. One network device may send data or control signaling to one or more terminals. A plurality of network devices may simultaneously send data or control signaling to one or more terminals.

A terminal device may send a network registration request message to a network device, to complete registration with a mobile communications network. Then, the terminal device may send a session establishment request message to the network device. The network device may establish a session for the terminal device based on the session establishment request message sent by the terminal device, and configure a user plane resource for the terminal device. Then, the terminal device may receive, on the user plane resource configured by the network device, downlink data sent by the network device, and the terminal device may send uplink data to the network device on the user plane resource configured by the network device. In this case, a communication link between the terminal device and the network device is established.

In some cases, the communication link between the terminal device and the network device may fail. The terminal device may periodically detect data packet receiving and sending, to determine whether the communication link between the terminal device and the network device fails. For example, in a detection cycle, if the terminal device detects no downlink data packet and/or no uplink data packet, the terminal device may assume that the communication link between the terminal device and the network device fails.

There are a plurality of causes of the failure of the communication link between the terminal device and the network device. In a first possible case, routing information of the terminal device is incorrectly configured. In a second possible case, the user plane resource of the terminal device is released. In a third possible case, session information of the terminal device is incorrectly configured or the session of the terminal device is released. In a fourth possible case, the terminal device deregisters from the mobile communications network. In addition, there may be a plurality of other causes of the failure of the communication link between the terminal device and the network device.

FIG. 2 shows a method for recovering a communication link between a terminal device and a network device according to an embodiment of this application.

201: A terminal device (terminal) determines, based on a data packet receiving and sending status, that a communication link between the terminal device and a network device (network) fails.

For example, in a first detection cycle, the terminal device may monitor a downlink data packet receiving status and/or an uplink data packet sending status. For example, uplink data may be sent by an application (application, app). If an uplink data packet is not successfully sent in the first detection cycle, or if a downlink data packet is not received in the first detection cycle, or if neither an uplink data packet is successfully sent nor a downlink data packet is received in the first detection cycle, a data packet receiving and sending exception may occur. Therefore, the terminal device may determine, based on the data packet receiving and sending status, that the communication link between the terminal device and the network device fails, and continue to perform the following steps.

202: The terminal device updates a route configuration based on routing information configured by the network device.

For example, in a process in which the terminal device accesses a mobile communications network, the terminal device may receive and store the routing information configured by the network device. After the communication link between the terminal device and the network device fails, the terminal device may read the pre-stored routing information, and update the route configuration based on the routing information. Updating the route configuration may further include querying session-related information and updating information such as a route. After the route configuration is updated, the terminal device may monitor a data packet receiving and sending status in a second detection cycle, to determine whether the communication link between the terminal device and the network device is recovered. The terminal device may cyclically perform step 202 a plurality of times. If the communication link is recovered, step 202 may be skipped, that is, execution of the method for recovering the communication link between the terminal device and the network device ends. If the communication link still cannot be recovered after step 202 is cyclically performed a plurality of times, step 203 may continue to be performed.

203: The terminal device releases a session and sends a session establishment request message to the network device, to re-establish a session.

In other words, the terminal device may deactivate the session, and then re-establish a session (protocol data unit (protocol data unit, PDU) session release and establishment—PDU session release and establishment). For example, the terminal device may release a session configured by the network device, and send a session establishment request message to the network device. The network device may establish a session for the terminal device based on the session establishment request message sent by the terminal device, and configure a user plane resource for the terminal device. The terminal device may cyclically perform step 203 a plurality of times. If the session is successfully established, the terminal device may receive and send messages on the user plane resource configured by the network device. This indicates that the communication link between the terminal device and the network device is recovered. Therefore, step 203 may be skipped, that is, execution of the method for recovering the communication link between the terminal device and the network device ends. If the session still cannot be successfully established after step 203 is cyclically performed a plurality of times, the communication link between the terminal device and the network device is still not recovered. Therefore, step 204 may continue to be performed.

204: The terminal device sends a network registration request message to the network device, to re-register with a mobile communications network.

For example, the terminal device may send the network registration request message to the network device, to re-register (re-register) with the mobile communications network. If the network registration succeeds, the terminal device may send a session establishment request message to the network device. The terminal device may cyclically perform step 204 a plurality of times. If the network device establishes a session for the terminal device based on the session establishment request message, and configures a user plane resource, and the terminal device can receive and send messages on the user plane resource configured by the network device, the communication link between the terminal device and the network device is recovered. Therefore, step 204 may be skipped, that is, execution of the method for recovering the communication link between the terminal device and the network device ends. If the terminal device still cannot successfully register with the network after step 203 is cyclically performed a plurality of times, the communication link between the terminal device and the network device is still not recovered. Therefore, step 205 may continue to be performed.

205: The terminal device switches a current communication status to an offline mode, switches out of the offline mode, and sends a network registration request message and a session establishment request message to the network device.

For example, the terminal device may enable the offline mode, to stop the terminal device from accessing the mobile communications network. Then, the terminal device disables the offline mode, and re-sends a network registration request message to the network device, to re-register with the mobile communications network. In other words, the terminal device may enable and disable the offline mode. In a process of enabling and disabling the offline mode, the terminal device may restart radio communication (restart radio). If the network registration succeeds, the terminal device may send a session establishment request message to the network device. The network device may establish a session for the terminal device based on the session establishment request message, and configure a user plane resource. Then, the terminal device may receive and send messages on the user plane resource configured by the network device. This indicates that the communication link between the terminal device and the network device is recovered. Therefore, step 205 may be skipped, that is, execution of the method for recovering the communication link between the terminal device and the network device ends.

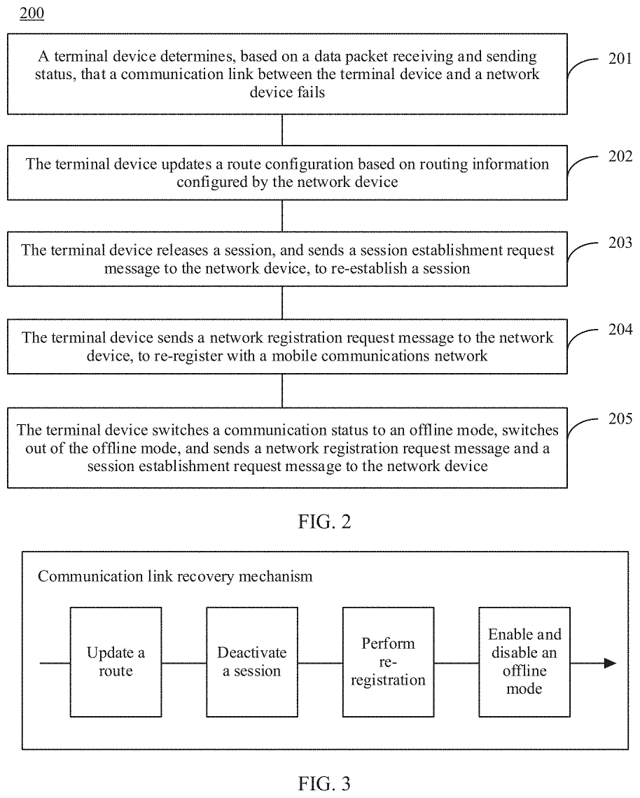

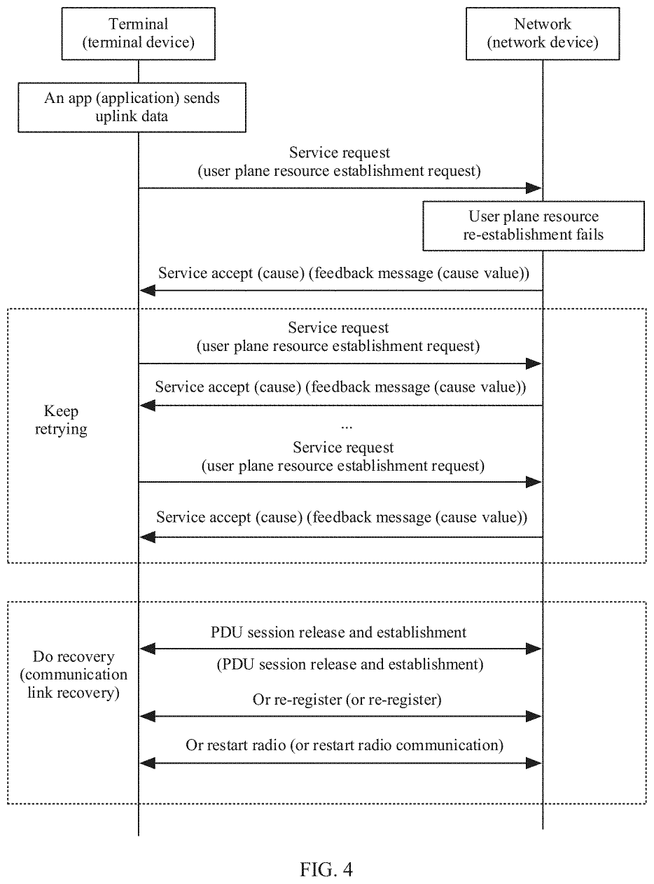

As described above, the terminal device may sequentially perform step 202 to step 205, to attempt to recover the communication link. FIG. 3 shows a communication link recovery mechanism in the method 200. The communication link recovery mechanism may be a do recovery (do recovery) mechanism of Android (Android). FIG. 4 shows a process of a user plane resource re-establishment failure. According to a first aspect, in a process of performing step 202 to step 205, the terminal device can determine, in only a monitoring manner, whether the communication link is recovered to a normal state. According to a second aspect, any one of step 202 to step 205 can resolve a communication link failure caused by only a specific type of factor. For example, step 202 is mainly for a communication link failure caused by a route configuration error. For another example, step 203 is mainly for a communication link failure caused by a session configuration error. For another example, step 204 is mainly for a communication link failure caused by a network registration error. For another example, step 205 is mainly for a communication link failure caused by an air interface configuration error. According to a third aspect, any one of step 202 to step 205 may be performed a plurality of times. Therefore, the method 200 for recovering the communication link between the terminal device and the network device may consume a relatively long time, and it is not conducive to quick recovery of the communication link.

This application provides a communication link recovery method, to shorten a time for recovering a communication link between a terminal device and a network device.

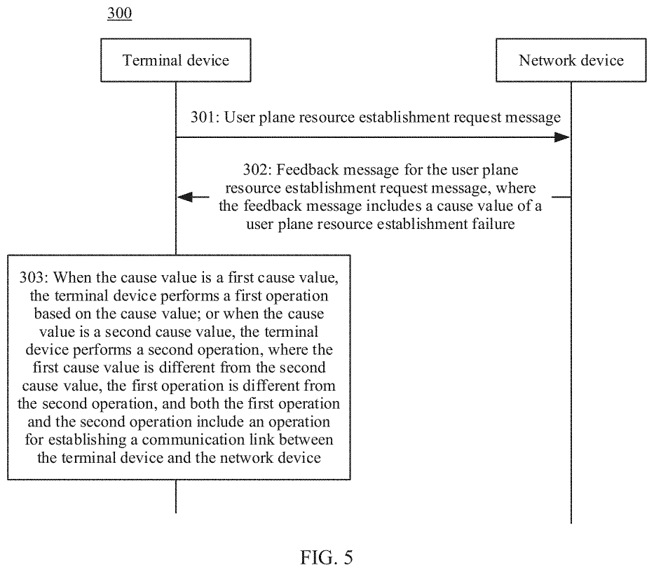

FIG. 5 is a schematic flowchart of a communication method according to an embodiment of this application.

301: A terminal device sends a user plane resource establishment request message to a network device.

Correspondingly, the network device receives the user plane resource establishment request message sent by the terminal device.

For example, the terminal device may send the user plane resource establishment request message (service request) to the network device in a scenario such as making a call, browsing a web page, or watching a video. If the network device successfully receives the user plane resource establishment request message, the network device may send a feedback message (service accept) for the user plane resource establishment request message to the terminal device. The feedback message may at least indicate that the network device receives the user plane resource establishment request message sent by the terminal device.

302: The network device sends the feedback message for the user plane resource establishment request message to the terminal device, where the feedback message includes a cause value (cause) of a user plane resource establishment failure.

Correspondingly, the terminal device receives the feedback message sent by the network device.

Table 1 shows cause values introduced in a 5G protocol.

TABLE 1

| Information | | | | | |
|---|---|---|---|---|---|
| element | | | | | |
| identifier | Information | | | | |
| (information | element | Type | Carried in a | | |
| element | (information | (type)/Protocol | message or not | Format | Length |
| identifier, IEI) | element, IE) | (reference) | (presence) | (format) | (length) |
| | Extended protocol | Extended | M (mandatory, | Value | 1 |
| | discriminator | protocol | to be carried | (value, V) | |
| | (extended protocol | discriminator | in the message) | | |
| | discriminator) | 9.2 | | | |
| | Security header | Security | M | V | ½ |
| | type (security | header type | | | |
| | header type) | 9.3 | | | |
| | Spare half octet | Spare | M | V | ½ |
| | (spare half octet) | half octet | | | |
| | | 9.5 | | | |
| | Service accept | Message type | M | V | 1 |
| | message identity | (message type) | | | |
| | (service accept | 9.7 | | | |
| | message identity) | | | | |
| 50 | PDU session | Protocol data | O (optional, | Type-length- | 4-34 |
| | status (PDU | unit session | may or may | value, type 4 | |
| | session status) | status | not be carried | (Type-length- | |
| | | 9.11.3.44 | in the message) | value, type 4, | |
| | | | | TLV) | |
| 26 | PDU session | PDU session | O | TLV | 4-34 |
| | reactivation | reactivation | | | |
| | result (PDU | result | | | |
| | session | 9.11.3.42 | | | |
| | reactivation | | | | |
| | result) | | | | |
| 72 | PDU session | PDU session | O | Type-length- | 5-515 |
| | reactivation | reactivation | | value, type 6 | |
| | result error | result error | | (Type-length- | |
| | cause value | cause value | | value, type 6, | |
| | (PDU session | 9.11.3.43 | | TLV-E) | |
| | reactivation | | | | |
| | result error | | | | |
| | cause) | | | | |
| 78 | Extensible | EAP message | O | TLV-E | 7-1503 |
| | authentication | 9.11.2.2 | | | |
| | protocol | | | | |
| | (extensible | | | | |
| | authentication | | | | |
| | protocol, EAP) | | | | |
| | message (EAP | | | | |
| | message) | | | | |

For clearer description, in this embodiment of this application, two possible cases in which the feedback message does not carry the cause value are first described. In a first possible case, the network device may successfully establish a user plane resource for the terminal device, so that the terminal device can use the user plane resource established by the network device. Therefore, the terminal device may not perform a subsequent step 303. In a second possible case, the network device cannot establish a user plane resource for the terminal device. When the feedback message indicates only that the network device successfully receives the user plane resource establishment request message, the terminal device cannot determine, based on the feedback message, whether a communication link between the terminal device and the network device fails, and cannot determine a specific reason why the communication link between the terminal device and the network device fails. Therefore, the terminal device needs to determine, on another basis (for example, a signaling receiving and sending status), whether the communication link between the terminal device and the network device fails. In addition, when the terminal device determines that the communication link fails, the terminal device needs to try a plurality of manners of recovering the communication link (for details, refer to the method 200 for recovering the communication link between the terminal device and the network device in FIG. 2).

If the feedback message for the user plane resource establishment request message indicates that the network device successfully receives the user plane resource establishment request message, and the feedback message further includes a cause value of the user plane resource establishment failure, it indicates that the network device can provide indication information for the terminal device based on a current network status, to indicate a status, a failure cause, and the like of the communication link between the terminal device and the network device.

This application is described by using the standard document 3gpp 24501-g10 in 5G mobility management (5th generation system mobility management, 5GMM) as an example. The standard document includes a plurality of types of cause values, and each cause value is used to indicate specific information. In this application, only some cause values in the standard are used as examples for description, and a person skilled in the art may figure out other embodiments with reference to the descriptions of this application and the instructions presented in the related accompanying drawings. Therefore, it should be understood that this application is not limited to the specific embodiments disclosed.

Cause value #22—Congestion

The cause value #22 is sent to a network due to network congestion (for example, there is no channel, or a facility is busy/congested).

Cause value #28—Restricted maintenance area

If UE requests a service in a tracking area that is a part of an unallowed area of the UE or is not a part of an allowed area of the UE, the cause value #28 may be sent to the UE.

Cause value #43—Local area data network (local area data network, LADN) not available

When UE is outside an LADN service area, the cause value #43 may be sent to the UE if a user plane resource of a protocol data unit (protocol data unit, PDU) session is not established.

Cause value #65—Maximum quantity of PDU sessions reached

When a network has reached a maximum quantity of PDU sessions simultaneously activated for UE, the network may use the cause value #65 to indicate that a procedure requested by the UE has been rejected.

Cause value #67—Insufficient resources for specific slice and DNN

A network may send the cause value #67 to indicate that a requested service cannot be provided due to insufficient resources for a specific slice and a data network name (Data Network Name, DNN).

Cause value #69—Insufficient resources for specific slice

A network may send the cause value #69 to indicate that a requested service cannot be provided due to insufficient resources for a specific slice.

Cause value #73—Serving network not authorized

If UE initiates registration with a serving network and the serving network fails to be authorized by a home network of the UE, the cause value #73 may be sent to the UE.

Cause value #90—Payload not forwarded

A network may send the cause value #90 to indicate that a requested service cannot be provided because load cannot be forwarded by an AMF.

Cause value #91—DNN not supported or not subscribed in slice

A network may send the cause value #91 to indicate that a requested service cannot be provided because payload cannot be forwarded by an AMF, because if UE does not indicate a slice, a DNN is not supported or subscribed to in a slice selected by the network, or a DNN is not supported or subscribed to in a slice indicated by UE.

Cause value #92—Insufficient user plane resources for PDU session

A network may send the cause value #92 to indicate that a requested service cannot be provided due to insufficient user plane resources for a PDU session.

Cause value #95—Semantically incorrect message

The cause value #95 is used to report a received message that has a semantically incorrect context.

Cause value #96—Invalid mandatory information

The cause value #96 indicates that a device sending the cause value #96 has received a message containing a non-semantic mandatory information element (information element, IE) error.

Cause value #97—Message type non-existent or not implemented

The cause value #97 indicates that a device sending the cause value #97 has received a message, and a message type of the message cannot be identified. This is because the message is an undefined message, or the message is defined but is not implemented by the device sending the cause value #97.

Cause value #98—Message type not compatible with protocol state

The cause value #98 indicates that a device sending the cause value #98 has received a message, and the message is not compatible with a protocol state.

Cause value #99—Information element non-existent or not implemented

The cause value #99 indicates that a device sending the cause value #99 has received a message, and the message includes an unidentified information element. This is because an identifier of the information element is not defined, or the identifier of the information element is defined but is not implemented by the device sending the cause value #99. However, to enable the device sending the cause value #99 to process the message, the information element does not need to be included in the message.

Cause value #100—Conditional IE error

The cause value #100 indicates that a device sending the cause value #100 has received a message with a conditional IE error.

Cause value #101—Message not compatible with protocol state

The cause value #101 indicates that a message not compatible with a protocol state has been received.

Cause value #111—Protocol error, unspecified

The cause value #111 is used to report a protocol error event only when no other 5GMM cause in a protocol error class applies.

303: When the cause value is a first cause value, the terminal device performs a first operation based on the cause value; or when the cause value is a second cause value, the terminal device performs a second operation, where the first cause value is different from the second cause value, the first operation is different from the second operation, and both the first operation and the second operation include an operation for establishing a communication link between the terminal device and the network device.

Because the terminal device receives the cause value sent by the network device, the terminal device may determine, based on the cause value, that the communication link between the terminal device and the network device fails. Compared with step 201 (that is, determining, by monitoring signaling receiving and sending, whether a communication link fails) shown in FIG. 2, the method for determining, based on the cause value, whether the communication link fails is quicker and more convenient.

In addition, the cause value can reflect a communication link status to some extent. Different cause values may reflect different communication link statuses. The terminal device may take a relatively targeted measure (that is, an operation corresponding to the cause value) based on the communication link status reflected by the cause value, skip an unnecessary step, and finally recover or re-establish the communication link between the terminal device and the network device. Therefore, recovering the communication link based on the cause value is relatively quick.

The terminal device may determine a failure status of the communication link between the terminal device and the network device based on the cause value. For example, if the communication link fails severely and is relatively difficult to recover, the terminal device may perform an operation for a severe communication link fault, and skip an operation for a minor communication link fault. For another example, if the communication link fails slightly and is relatively easy to recover, the terminal device may cyclically perform an operation for a minor communication link fault a plurality of times.

Optionally, the operation for establishing a communication link between the terminal device and the network device includes at least one of the following: an operation 1: updating a route configuration; an operation 2: re-sending the user plane resource establishment request message to the network device; an operation 3: releasing a session resource and sending a session establishment request message to the network device; an operation 4: sending a first deregistration request message to the network device, and sending a first registration request message for a first communications network to the network device, where the first deregistration request message is used to cancel registration with the first communications network, and the first registration request message is used to establish the communication link between the terminal device and the network device by using the first communications network; an operation 5: enabling an offline mode and disabling the offline mode; and an operation 6: sending a second deregistration request message to the network device, and sending a second registration request message for a second communications network to the network device, where the second deregistration request message is used to cancel registration with a used third communications network, and the second registration request message is used to establish the communication link between the terminal device and the network device by using the second communications network.

In an example, that the terminal device updates the route configuration may refer to that the terminal device reads routing information from a memory and updates the route configuration based on the routing information. Updating the route configuration may further include querying session-related information and updating information such as a route.

In an example, that the terminal device re-sends the user plane resource establishment request message to the network device may refer to that step 301 is re-performed. Then, the terminal device may receive a new feedback message sent by the network device. The foregoing has described in detail three possible cases for different types of feedback messages, and details are not described herein again.

In an example, that the terminal device releases the session resource (for example, sends a session release request message (PDU SESSION RELEASE REQUEST)), and sends the session establishment request message (PDU SESSION ESTABLISHMENT REQUEST) to the network device may refer to that the terminal device deactivates a session (a network-requested PDU session release procedure (Network-requested PDU session release procedure)), and then re-establishes a session. The network device may re-establish a session by using a same session parameter (for example, a data network name (data network name, DNN) or a single network slice (single network slice selection assistance information. S-NSSAI)). The network device may send a session establishment accept message (PDU SESSION ESTABLISHMENT ACCEPT) for the session establishment request message. That the terminal device releases the session resource and sends the session establishment request message to the network device may include at least the following two cases. In a first case, the network device may establish a session for the terminal device based on the session establishment request message sent by the terminal device, and configure a user plane resource for the terminal device. In this case, the terminal device may receive and send messages on the user plane resource configured by the network device. In a second case, the network device cannot establish a session for the terminal device, and therefore the network device cannot configure a user plane resource for the terminal device.

In an example, that the terminal device sends the first deregistration request message to the network device, and sends the first registration request message for the first communications network to the network device may refer to that the terminal device re-registers with the first communications network, or may refer to that the terminal device first deregisters from the first communications network and then re-registers with the first communications network. A network deregistration request may be DEREGISTRATION REQUEST. The network device may send a deregistration request accept message (DEREGISTRATION ACCEPT) for the network deregistration request. Then, there may be at least the following three cases. In a first case, registration with the first communications network succeeds. The terminal device may send a session establishment request message to the network device. In addition, the network device may establish a session for the terminal device based on the session establishment request message, and configure a user plane resource for the terminal device. Finally, the terminal device may receive and send messages on the user plane resource configured by the network device. In a second case, registration with the first communications network succeeds. The terminal device may send a session establishment request message to the network device. However, the network device cannot establish a session for the terminal device, and therefore cannot configure a user plane resource for the terminal device. In a third case, registration with the first communications network fails. The terminal device cannot send or receive a message by using the first communications network.

In an example, enabling the offline mode and disabling the offline mode may refer to that the terminal device switches a current communication status to the offline mode, and then switches out of the offline mode. In a process of enabling and disabling the offline mode, a mobile communications module of the terminal device may be restarted. Then, the terminal device may send a network registration request message to the network device, where the network registration request message is used to register with a mobile communications network. A process of re-registering with a network may include at least three cases, and this has been described in detail in the foregoing example. Details are not described herein again.

In an example, sending the second deregistration request message to the network device, and sending the second registration request message for the second communications network to the network device may refer to that the terminal device disables the third communications network and enables the second communications network, or may refer to that the terminal device first deregisters from the third communications network and then re-registers with the second communications network. Then, there may be at least the following three cases. In a first case, registration with the second communications network succeeds. The terminal device may send a session establishment request message to the network device. In addition, the network device may establish a session for the terminal device based on the session establishment request message, and configure a user plane resource for the terminal device. Finally, the terminal device may receive and send messages on the user plane resource configured by the network device. In a second case, registration with the second communications network succeeds. The terminal device may send a session establishment request message to the network device. However, the network device cannot establish a session for the terminal device, and therefore cannot configure a user plane resource for the terminal device. In a third case, registration with the second communications network fails. The terminal device cannot send or receive a message by using the second communications network.

The first communications network may be, for example, a 5G communications network, an NR communications network, or a 6G communications network. A specific type of the first communications network is not limited in this application.

The second communications network may be, for example, a GSM communications network, a UMTS communications network, or an LTE communications network. A specific type of the second communications network is not limited in this application.

The third communications network may be, for example, a 5G communications network, an NR communications network, or a 6G communications network. A specific type of the third communications network is not limited in this application. When the third communications network is an NR communications network, deregistering from the third communications network may refer to disabling NR.

Optionally, the sending a second deregistration request message to the network device, and sending a second registration request message for a second communications network to the network device further includes: setting a timer, where the timer is used to time a process of using the second communications network, and when the timer reaches a preset threshold, sending a third deregistration request message to the network device, and sending a third registration request message for the third communications network to the network device, where the third deregistration request message is used to cancel registration with the second communications network, and the third registration request message is used to establish the communication link between the terminal device and the network device by using the third communications network.

In other words, after disabling the third communications network, the terminal device may enable the timer, to determine duration in which the terminal device does not enable the third communications network. Alternatively, after enabling the second communications network, the terminal device may enable the timer, to determine duration in which the terminal device enables the second communications network. When the timer reaches the preset threshold, it indicates that the duration in which the terminal device does not enable the third communications network is relatively long, or the duration in which the terminal device enables the second communications network is relatively long. In this case, for some reasons (for example, network congestion does not exist), the terminal device can successfully receive and send messages by using the third communications network Therefore, the terminal device may send the third registration request message to the network device, to re-register with the third communications network. Sending the third deregistration request message to the network device may be referred to as a detaching (detach) process. Sending the third registration request message to the network device may be referred to as an attaching (attach) process.

When the third communications network is an NR communications network, the timer may be referred to as a reenable NR timer.

Optionally, before the timer reaches the preset threshold, the sending a second deregistration request message to the network device, and sending a second registration request message for a second communications network to the network device further includes: displaying an identifier of the second communications network; and after the sending a third registration request message for the third communications network to the network device, the sending a second deregistration request message to the network device, and sending a second registration request message for a second communications network to the network device further includes: displaying an identifier of the third communications network.

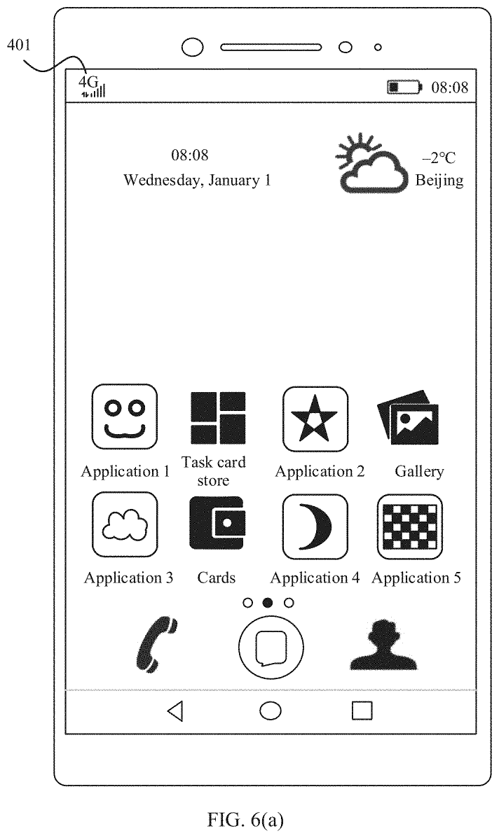

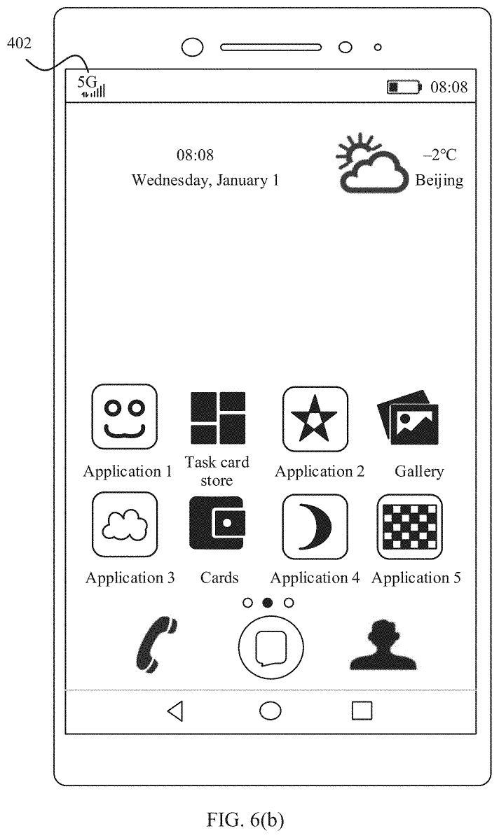

An example in which the third communications network is a 5G communications network and the second communications network is a 4G communications network is used below for description. As shown in FIG. 6(a), after completing registration with the second communications network, the terminal device may display an identifier 401 of the 4G communications network in a user interface. Then, when the timer reaches the preset threshold (the preset threshold may be, for example, 10 ms), the terminal device may send the third registration request message to the network device, to re-register with the third communications network. After completing registration with the third communications network, the terminal device may display an identifier 402 of the 5G communications network in a user interface (user interface, UI) (as shown in FIG. 6(b)).

Optionally, the sending a second deregistration request message to the network device, and sending a second registration request message for a second communications network to the network device further includes: sending indication information to the network device, where the indication information is used to indicate that the terminal device does not support the third communications network.

That the terminal device does not support the third communications network may refer to that the terminal device does not send or receive a message by using the third communications network. In other words, after receiving the indication information sent by the terminal device, the network device may not send a message to the terminal device by using the third communications network within a period of time. Therefore, a signaling loss can be reduced. The network device may allocate a resource of the third communications network that is originally allocated to the terminal device to another terminal device. This helps improve signaling receiving and sending efficiency.

Optionally, when the timer reaches the preset threshold, indication information used to indicate that the terminal device supports the third communications network may be sent to the network device.

It should be understood that, when operations for establishing the communication link include the operation 4 and the operation 6, and the operation 6 is performed after the operation 4 is performed, the third communications network and the first communications network may be a same communications network.

A plurality of examples of the operation for establishing the communication link have been described above. A relationship between the first operation and the second operation is described herein by using some examples. A person skilled in the art may figure out other embodiments with reference to the descriptions of this application and the instructions presented in the related accompanying drawings. Therefore, it should be understood that this application is not limited to the specific embodiments disclosed.

### Example 1

It is assumed that there are L operations for establishing the communication link between the terminal device and the network device, and L is a positive integer greater than or equal to 2. The first operation may include an i^{th} operation in the L operations. The second operation may include a j^{th} operation in the L operations, both i and j are positive integers less than or equal to L, and i≠j. When the terminal device receives the first cause value, the terminal device may perform the i^{th} operation. When the terminal device receives the second cause value, the terminal device may perform the j^{th} operation.

For example, operations for establishing the communication link between the terminal device and the network device include the operation 1, the operation 2, the operation 3, the operation 4, the operation 5, and the operation 6. When the terminal device receives the first cause value, the terminal device may perform the operation 2. When the terminal device receives the second cause value, the terminal device may perform the operation 4. Table 2 shows a correspondence between a cause value and an operation.

TABLE 2

| Cause value | Corresponding operation |
|---|---|
| First | Operation 2 - Re-send a user plane resource |
| cause value | establishment request message to the network device |
| Second | Operation 4 - Send a first deregistration request |
| cause value | message to the network device, and send a first |
| | registration request message for a first |
| | communications network to the network device |

### Example 2

It is assumed that there are L operations for establishing the communication link between the terminal device and the network device, and L is a positive integer greater than or equal to 2. The first operation may include m operations in the L operations. The m operations may be a plurality of sub-operations of the first operation. The second operation may include n operations in the L operations. The m operations are different from the n operations, and both m and n are positive integers less than or equal to L. The n operations may be a plurality of sub-operations of the second operation. That the m operations are different from the n operations may refer to that the m operations include operations other than the n operations in the L operations, or that the n operations include operations other than the m operations in the L operations.

For example, operations for establishing the communication link between the terminal device and the network device include the operation 1, the operation 2, the operation 3, the operation 4, the operation 5, and the operation 6. When the terminal device receives the first cause value, the terminal device may perform the operation 1, the operation 4a the operation 5, and the operation 6. When the terminal device receives the second cause value, the terminal device may perform the operation 1, the operation 2, the operation 3, the operation 4, the operation 5, and the operation 6. Table 3 shows a correspondence between a cause value and an operation.

TABLE 3

| Cause value | Corresponding operation |
|---|---|
| First | Operation 1 - Update a route configuration |
| cause value | Operation 4 - Send a first deregistration request |
| | message to the network device, and send a first |
| | registration request message for a first |
| | communications network to the network device |
| | Operation 5 - Enable an offline mode and disable |
| | the offline mode |
| | Operation 6 - Send a second deregistration request |
| | message to the network device, and send a second |
| | registration request message for a second |
| | communications network to the network device |
| Second | Operation 1 - Update a route configuration |
| cause value | Operation 2 - Re-send a user plane resource |
| | establishment request message to the network device |
| | Operation 3 - Release a session resource and send a |
| | session establishment request message to the network |
| | device |
| | Operation 4 - Send a first deregistration request |
| | message to the network device, and send a first |
| | registration request message for a first |
| | communications network to the network device |
| | Operation 5 - Enable an offline mode and disable the |
| | offline mode |
| | Operation 6 - Send a second deregistration request |
| | message to the network device, and send a second |
| | registration request message for a second |
| | communications network to the network device |

Optionally, the first operation includes K sub-operations, the K sub-operations are in a one-to-one correspondence with K priorities, and that the terminal device performs the first operation includes: The terminal device performs the K sub-operations based on the K priorities.

In other words, the terminal device may perform a plurality of sub-operations in descending order of priorities.

### Example 3

It is assumed that the terminal device receives the first cause value. Then, the terminal device may perform the first operation. Table 4 shows the first cause value, the first operation, and priorities of a plurality of sub-operations of the first operation. A smaller priority value may indicate a higher priority.

TABLE 4

| Cause value | Corresponding operation | Priority |
|---|---|---|
| First | Operation 1 - Update a route configuration | 1 |
| cause value | Operation 2 - Re-send a user plane resource | 2 |
| | establishment request message to the network | |
| | device | |
| | Operation 3 - Release a session resource and | 3 |
| | send a session establishment request message | |
| | to the network device | |
| | Operation 4 - Send a first deregistration | 4 |
| | request message to the network device, and | |
| | send a first registration request message | |
| | for a first communications network to the | |
| | network device | |
| | Operation 5 - Enable an offline mode and | 5 |
| | disable the offline mode | |
| | Operation 6 - Send a second deregistration | 6 |
| | request message to the network device, and | |
| | send a second registration request message | |
| | for a second communications network to the | |
| | network device | |

It can be seen that the first operation may include the operation 1, the operation 2, the operation 3, the operation 4, the operation 5, and the operation 6. A priority corresponding to the operation 1 is 1, a priority corresponding to the operation 2 is 2, a priority corresponding to the operation 3 is 3, a priority corresponding to the operation 4 is 4, a priority corresponding to the operation 5 is 5, and a priority corresponding to the operation 6 is 6. The terminal device may perform the operations 1 to 6 in descending order of the priorities of the operations 1 to 6 in the first operation, that is, perform the first operation in an order of operation 1->operation 2->operation 3->operation 4->operation 5->operation 6.

It is assumed that the terminal device receives the first cause value. Therefore, the terminal device may perform the first operation. If the communication link between the terminal device and the network device can be successfully recovered after the terminal device performs any sub-operation of the first operation, the terminal device may stop performing another operation after the any sub-operation of the first operation. The example 3 is used as an example. It is assumed that the terminal device sequentially performs the operation 1, the operation 2, the operation 3, and the operation 4, and prepares to perform the operation 5 and the operation 6. However, after the terminal device performs the operation 4, the communication link between the terminal device and the network device can be successfully recovered. In this case, the terminal device may no longer perform the operation 5 or the operation 6. That is, the operation corresponding to the cause value may be interrupted because the communication link is successfully recovered.

Optionally, the first cause value belongs to a first cause value type, the second cause value belongs to a second cause value type, the first cause value type includes one or more of a cause value #65, a cause value #67, a cause value #69, and a cause value #92, and the second cause value type includes one or more of a cause value #95, a cause value #96, a cause value #97, a cause value #100, and a cause value #101. That the terminal device performs a first operation when the cause value is a first cause value includes: The terminal device performs the first operation when the cause value belongs to the first cause value type. That the terminal device performs a second operation when the cause value is a second cause value includes: The terminal device performs the second operation when the cause value belongs to the second cause value type.

In other words, the terminal device may set a plurality of cause value types, for example, the first cause value type and the second cause value type. If the cause value received by the terminal device belongs to the first cause value type, the terminal device performs an operation (for example, the first operation) corresponding to the first cause value type. If the cause value received by the terminal device belongs to the second cause value type, the terminal device may perform an operation (for example, the second operation) corresponding to the second cause value type.

### Example 4

The first cause value type may include, for example, the cause value #65, the cause value #67, the cause value #69, and the cause value #92. The first operation corresponding to the first cause value type may include, for example, the operation 1, the operation 2, the operation 3, the operation 4, the operation 5, and the operation 6. Therefore, if the terminal device receives any one of the cause value #65, the cause value #67, the cause value #69, and the cause value #92, the terminal device may determine to perform the first operation, where the first operation includes the operation 1, the operation 2, the operation 3, the operation 4, the operation 5, and the operation 6.

The second cause value type may include, for example, the cause value #95, the cause value #96, the cause value #97, the cause value #100, and the cause value #101. The second operation corresponding to the second cause value type may include, for example, the operation 4, the operation 5, and the operation 6. Therefore, if the terminal device receives any one of the cause value #95, the cause value #96, the cause value #97, the cause value #100, and the cause value #101, the terminal device may determine to perform the second operation, where the second operation includes the operation 4, the operation 5, and the operation 6.

Table 5 shows a correspondence between a cause value type and an operation.

TABLE 5

| Cause | Cause | |
|---|---|---|
| value | value type | Corresponding operation |
| Cause | First cause | Operation 1 - Update a route configuration |
| value | value type | Operation 2 - Re-send a user plane resource |
| #65 | | establishment request message to the network |
| Cause | | device |
| value | | Operation 3 - Release a session resource and |
| #67 | | send a session establishment request message |
| Cause | | to the network device |
| value | | Operation 4 - Send a first deregistration |
| #69 | | request message to the network device, and |
| Cause | | send a first registration request message |
| value | | for a first communications network to the |
| #92 | | network device |
| | | Operation 5 - Enable an offline mode and |
| | | disable the offline mode |
| | | Operation 6 - Send a second deregistration |
| | | request message to the network device, and |
| | | send a second registration request message |
| | | for a second communications network to the |
| | | network device |
| Cause | Second cause | Operation 4 - Send a first deregistration |
| value | value type | request message to the network device, and |
| #95 | | send a first registration request message |
| Cause | | for a first communications network to the |
| value | | network device |
| #96 | | Operation 5 - Enable an offline mode and |
| Cause | | disable the offline mode |
| value | | Operation 6 - Send a second deregistration |
| #97 | | request message to the network device, and |
| Cause | | send a second registration request message |
| value | | for a second communications network to the |
| #100 | | network device |
| Cause | | |
| value | | |
| #101 | | |

Optionally the first operation includes cyclically performing a target sub-operation M times, the second operation includes cyclically performing the target sub-operation N times, both M and N are positive integers, and M is not equal to N.

That is, a maximum quantity of cycles of performing the target sub-operation in the first operation is M, and a maximum quantity of cycles of performing the target sub-operation in the second operation is N. Both M and N are positive integers, and M is not equal to N.

### Example 5

Table 6 shows the first operation corresponding to the first cause value and the second operation corresponding to the second cause value. The first operation may include the foregoing operations 1 to 6, where the operation 2 is cyclically performed twice, the operation 3 is cyclically performed three times, and the operation 4 is performed once. The first operation may include the foregoing operations 1 to 6, where the operation 2 is cyclically performed five times, the operation 3 is cyclically performed 10 times, and the operation 4 is cyclically performed twice.

TABLE 6

| Cause | | Quantity |
|---|---|---|
| value | Corresponding operation | of cycles |
| First | Operation 1 - Update a route configuration | 1 |
| cause value | Operation 2 - Re-send a user plane resource | 2 |
| | establishment request message to the network | |
| | device | |
| | Operation 3 - Release a session resource and | 2 |
| | send a session establishment request message | |
| | to the network device | |
| | Operation 4 - Send a first deregistration | 1 |
| | request message to the network device, and | |
| | send a first registration request message | |
| | for a first communications network to the | |
| | network device | |
| | Operation 5 - Enable an offline mode and | 1 |
| | disable the offline mode | |
| | Operation 6 - Send a second deregistration | 1 |
| | request message to the network device, and | |
| | send a second registration request message | |
| | for a second communications network to the | |
| | network device | |
| Second | Operation 1 - Update a route configuration | 1 |
| cause value | Operation 2 - Re-send a user plane resource | 5 |
| | establishment request message to the network | |
| | device | |
| | Operation 3 - Release a session resource and | 10 |
| | send a session establishment request message | |
| | to the network device | |
| | Operation 4 - Send a first deregistration | 2 |
| | request message to the network device, and | |
| | send a first registration request message | |
| | for a first communications network to the | |
| | network device | |
| | Operation 5 - Enable an offline mode and | 1 |
| | disable the offline mode | |
| | Operation 6 - Send a second deregistration | 1 |
| | request message to the network device, and | |
| | send a second registration request message | |
| | for a second communications network to the | |
| | network device | |

It is assumed that the terminal device receives the first cause value. Then, the terminal device may perform the target sub-operation of the first operation. An example in which the target sub-operation is the foregoing operation 2: re-sending a user plane resource establishment request message to the network device, is used below for description. It is assumed that a user plane resource establishment request message sent by the terminal device for the i^{th} time is an i^{th} user plane resource establishment request message, where i≤M. In a possible case, the first operation may be cyclically performed by the terminal device m times, and the terminal device performs signaling receiving and sending on a user plane resource corresponding to an m^{th} user plane resource establishment request message, where i≤m≤M. In another possible case, after sending an M^{th} user plane resource establishment request message, the terminal device cannot use a user plane resource corresponding to the M^{th} user plane resource establishment request message.

### Example 6

The terminal device may set a plurality of cause value types, for example, the first cause value type and the second cause value type. If the cause value received by the terminal device belongs to the first cause value type, the terminal device may determine a quantity of cycles corresponding to the first cause value type as a quantity of cycles of performing the target sub-operation. If the cause value received by the terminal device belongs to the second cause value type, the terminal device may determine a quantity of cycles corresponding to the second cause value type as a quantity of cycles of performing the target sub-operation.

The first cause value type may include, for example, the cause value #65, the cause value #67, the cause value #69, and the cause value #92. The quantity of cycles corresponding to the first cause value type may be, for example, 2. Therefore, if the terminal device receives any one of the cause value #65, the cause value #67, the cause value #69, and the cause value #92, the terminal device may determine to cyclically perform the target sub-operation twice.

The second cause value type may include, for example, the cause value #95, the cause value #96, the cause value #97, the cause value #100, and the cause value #101. The quantity of cycles corresponding to the second cause value type may be, for example, 5. Therefore, if the terminal device receives any one of the cause value #95, the cause value #96, the cause value #97, the cause value #100, and the cause value #101, the terminal device may determine to cyclically perform the target sub-operation five times.

Table 7 shows a correspondence between a cause value type and a quantity of cycles of performing the target sub-operation.

TABLE 7

| Cause | Cause | | Quantity |
|---|---|---|---|
| value | value type | Target sub-operation | of cycles |
| Cause | First cause | Operation 2 - Re-send a user | 2 |
| value | value type | plane resource establishment | |
| #65 | | request message to the network | |
| Cause | | device | |
| value | | | |
| #67 | | | |
| Cause | | | |
| value | | | |
| #69 | | | |
| Cause | | | |
| value | | | |
| #92 | | | |
| Cause | Second cause | | 5 |
| value | value type | | |
| #95 | | | |
| Cause | | | |
| value | | | |
| #96 | | | |
| Cause | | | |
| value | | | |
| #97 | | | |
| Cause | | | |
| value | | | |
| #100 | | | |
| Cause | | | |
| value | | | |
| #101 | | | |

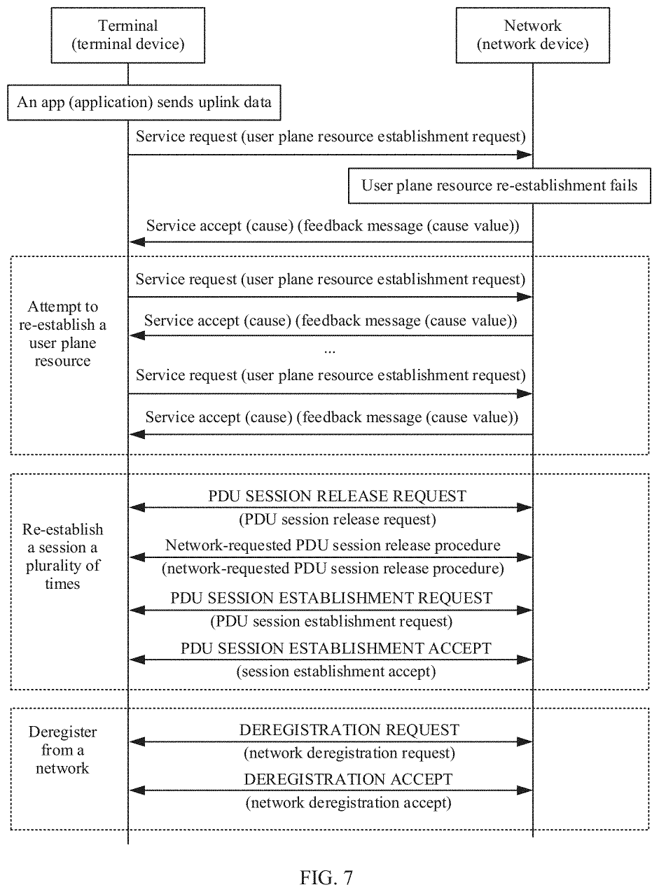

FIG. 7 is a schematic flowchart of a communication link recovery method according to an embodiment of this application. As shown in FIG. 7, operations corresponding to the cause value may include re-establishing a session a plurality of times and deregistering from a network.

In this embodiment of this application, the terminal device can relatively quickly determine, based on the cause value sent by the network device, whether the communication link fails. In addition, the terminal device may take a relatively targeted measure (that is, an operation corresponding to the cause value) and skip an unnecessary step, so that the communication link between the terminal device and the network device can be relatively quickly recovered.

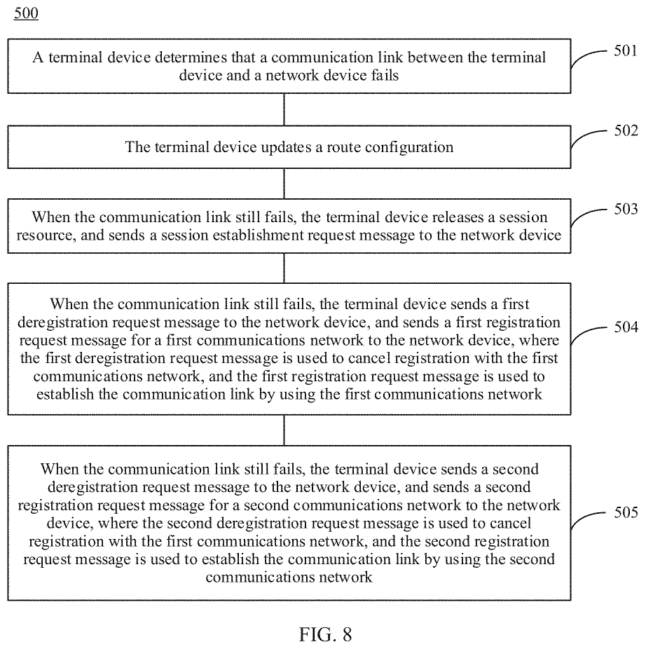

FIG. 8 shows a communication method according to an embodiment of this application.

501: A terminal device determines that a communication link between the terminal device and a network device fails.

In an example, the terminal device may determine, based on a signaling receiving and sending status, that the communication link between the terminal device and the network device fails. For details, refer to step 201 in the embodiment shown in FIG. 2. Details are not described herein again.

In an example, the terminal device may determine, based on a cause value sent by the network device, that the communication link between the terminal device and the network device fails, where the cause value is included in a feedback message for a user plane resource request message. For details, refer to steps 301 and 302 in the embodiment shown in FIG. 5. Details are not described herein again.

502: The terminal device updates a route configuration.

503: When the communication link between the terminal device and the network device still fails, the terminal device releases a session resource, and sends a session establishment request message to the network device.

504: When the communication link between the terminal device and the network device still fails, the terminal device sends a first deregistration request message to the network device, and sends a first registration request message for a first communications network to the network device, where the first deregistration request message is used to cancel registration with the first communications network, and the first registration request message is used to establish the communication link between the terminal device and the network device by using the first communications network.

For a specific implementation of step 501 to step 504, refer to step 201 to step 204 in the embodiment shown in FIG. 2 or step 303 in the embodiment shown in FIG. 5. Details are not described herein.

505: When the communication link between the terminal device and the network device still fails, the terminal device sends a second deregistration request message to the network device, and sends a second registration request message for a second communications network to the network device, where the second deregistration request message is used to cancel registration with the first communications network, and the second registration request message is used to establish the communication link between the terminal device and the network device by using the second communications network.

In some cases, a reason why the communication link between the terminal device and the network device fails may be that a fault occurs on a network side. In other words, it may be difficult for the terminal device to attach to the first communications network. The terminal device may choose to attach to another communications network. For a specific implementation of step 505, refer to step 303 in the embodiment shown in FIG. 5. Details are not described herein again.

Optionally, the communication method further includes: The terminal device sets a timer, where the timer is used to time a process of using the second communications network, and when the timer reaches a preset threshold, the terminal device sends a third deregistration request message to the network device, and sends a third registration request message for the first communications network to the network device, where the third deregistration request message is used to cancel registration with the second communications network, and the third registration request message is used to establish the communication link between the terminal device and the network device by using the first communications network.

Optionally, before the timer reaches the preset threshold, the communication method further includes: The terminal device displays an identifier of the second communications network. After the terminal device sends the third registration request message for the first communications network to the network device, the communication method further includes: The terminal device displays an identifier of the first communications network.

Optionally, the communication method further includes: The terminal device sends indication information to the network device, where the indication information is used to indicate that the terminal device does not support the first communications network.

Optionally, before the terminal device releases the session resource, when the communication link between the terminal device and the network device still fails, the communication method further includes: The terminal device sends a user plane resource establishment request message to the network device.

Compared with re-establishing a session, re-configuring a user plane resource takes a relatively short time. If re-configuring the user plane resource can effectively resolve a communication link failure, a process of recovering the communication link can be relatively quick and effective. In addition, in some communication systems, the network device may feed back a cause value of a user plane resource establishment failure for a user plane resource establishment request message. As described above, the terminal device may determine, based on the cause value, that the communication link between the terminal device and the network device fails.

Optionally, before the terminal device sends the second deregistration request message to the network device, when the communication link between the terminal device and the network device still fails, the communication method further includes: The terminal device enables an offline mode and disables the offline mode.

On some terminal devices, a user may tap an icon corresponding to the “offline mode” in a user interface of the terminal device, to control the terminal device to enable the offline mode. Then, the user may tap the icon corresponding to the “offline mode” again, to control the terminal device to disable the offline mode. However, if the terminal device cannot automatically switch a communications mode to the offline mode, and then automatically switch the communications mode out of the offline mode, a mobile communications module of the terminal device cannot be restarted. Therefore, switching the communications mode to the offline mode and then switching the communications mode out of the offline mode may recover a communication link failure caused by some reasons. After disabling the offline mode, the terminal device may choose to attach to the first communications network or the second communications network.

FIG. 9 is a schematic diagram of a structure of a communication apparatus according to an embodiment of this application. The communication apparatus may be a terminal device, or may be a component (for example, a chip or a circuit) that can be used in the terminal device. As shown in FIG. 9, the communication apparatus 600 may include a transceiver module 601 and a processing module 602.

The transceiver module 601 is configured to send a user plane resource establishment request message to a network device.

The transceiver module 601 is further configured to receive a feedback message sent by the network device for the user plane resource establishment request message, where the feedback message includes a cause value of a user plane resource establishment failure.

The processing module 602 is configured to perform a first operation when the cause value is a first cause value.

The processing module 602 is alternatively configured to perform a second operation when the cause value is a second cause value. The first cause value is different from the second cause value, the first operation is different from the second operation, and both the first operation and the second operation include an operation for establishing a communication link between the terminal device and the network device.

The transceiver module 601 may be implemented by a receiver and/or a transmitter. The processing module 602 may be implemented by a processor. For specific functions and beneficial effects of the transceiver module 601 and the processing module 602, refer to the communication method shown in FIG. 5. Details are not described herein again.

In a possible embodiment, a communication apparatus is further provided. The communication apparatus may be a terminal device, or may be a component (for example, a chip or a circuit) that can be used in the terminal device. The communication apparatus may include a transceiver and a processor, and optionally, may further include a memory. The transceiver may be configured to implement corresponding functions and operations of the receiving module and the sending module. The processor may be configured to implement a corresponding function and operation of the processing module. The memory may be configured to store executable instructions or application program code, and the processor controls execution of the executable instructions or the application program code, to implement the communication method provided in the foregoing embodiments of this application; and/or the memory may be configured to temporarily store some data, instruction information, and the like. The memory may be independent of the processor. In this case, the memory may be connected to the processor through a communications line. In another possible design, the memory may alternatively be integrated with the processor. This is not limited in this embodiment of this application.

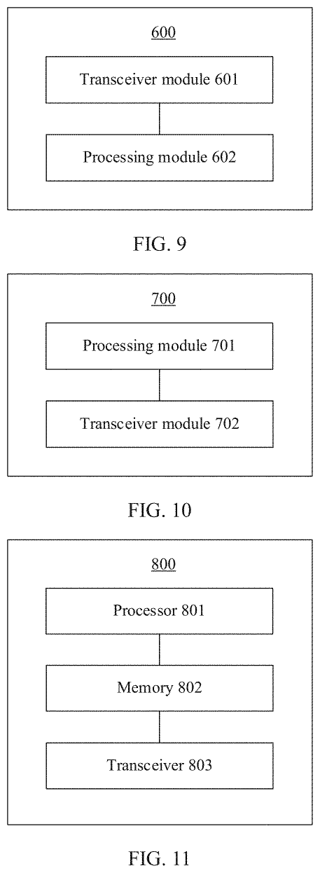

FIG. 10 is a schematic diagram of a structure of a communication apparatus according to an embodiment of this application. The communication apparatus may be a terminal device, or may be a component (for example, a chip or a circuit) that can be used in the terminal device. As shown in FIG. 10, the communication apparatus 700 may include a processing module 701 and a transceiver module 702.

The processing module 701 is configured to determine that a communication link between the terminal device and a network device fails.

The processing module 701 is further configured to update a route configuration.

The transceiver module 702 is configured to: when the communication link between the terminal device and the network device still fails, release a session resource, and send a session establishment request message to the network device.

The transceiver module 702 is further configured to: when the communication link between the terminal device and the network device still fails, send a first deregistration request message to the network device, and send a first registration request message for a first communications network to the network device. The first deregistration request message is used to cancel registration with the first communications network, and the first registration request message is used to establish the communication link between the terminal device and the network device by using the first communications network.

The transceiver module 702 is further configured to, when the communication link between the terminal device and the network device still fails, send a second deregistration request message to the network device, and send a second registration request message for a second communications network to the network device. The second deregistration request message is used to cancel registration with the first communications network, and the second registration request message is used to establish the communication link between the terminal device and the network device by using the second communications network.

The processing module 701 may be implemented by a processor. The transceiver module 702 may be implemented by a receiver and/or a transmitter. For specific functions and beneficial effects of the processing module 701 and the transceiver module 702, refer to the communication method shown in FIG. 8. Details are not described herein again.

In a possible embodiment, a communication apparatus is further provided. The communication apparatus may be a terminal device, or may be a component (for example, a chip or a circuit) that can be used in the terminal device. The communication apparatus may include a transceiver and a processor, and optionally, may further include a memory. The transceiver may be configured to implement corresponding functions and operations of the receiving module and the sending module. The processor may be configured to implement a corresponding function and operation of the processing module. The memory may be configured to store executable instructions or application program code, and the processor controls execution of the executable instructions or the application program code, to implement the communication method provided in the foregoing embodiments of this application; and/or the memory may be configured to temporarily store some data, instruction information, and the like. The memory may be independent of the processor. In this case, the memory may be connected to the processor through a communications line. In another possible design, the memory may alternatively be integrated with the processor. This is not limited in this embodiment of this application.

FIG. 11 is a block diagram of a structure of a communication apparatus according to an embodiment of the present invention. The communication apparatus may be a terminal device. As shown in FIG. 11, the terminal device includes a processor 801, a memory 802, a radio frequency circuit, an antenna, and an input/output apparatus. The processor 801 may be configured to process a communications protocol and communications data, control the terminal device, execute a software program, process data of the software program, and the like. The memory 802 is mainly configured to store a software program and data. The radio frequency circuit is mainly configured to perform conversion between a baseband signal and a radio frequency signal, and process the radio frequency signal. The antenna is mainly configured to receive and send radio frequency signals in a form of an electromagnetic wave. The input/output apparatus, such as a touchscreen, a display, or a keyboard, is mainly configured to receive data entered by a user, and output data to the user. It should be noted that some types of terminal devices may have no input/output apparatus.

When data needs to be sent, after performing baseband processing on the to-be-sent data, the processor 801 outputs a baseband signal to the radio frequency circuit; and the radio frequency circuit performs radio frequency processing on the baseband signal and then sends the radio frequency signal to the outside in a form of an electromagnetic wave through the antenna. When data is sent to the terminal device, the radio frequency circuit receives a radio frequency signal through the antenna, converts the radio frequency signal into a baseband signal, and outputs the baseband signal to the processor. The processor converts the baseband signal into data, and processes the data. For ease of description, FIG. 1I shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna and the radio frequency circuit that have receiving and sending functions may be considered as a transceiver 803 of the terminal device, and the processor having a processing function may be considered as a processing unit of the terminal device. The transceiver may also be referred to as a transceiver unit, a transceiver apparatus, or the like. The processing unit may also be referred to as a processor, a processing board, a processing module, a processing apparatus, or the like. Optionally, a component that is in the transceiver 803 and that is configured to implement a receiving function may be considered as a receiving unit, and a component that is in the transceiver 803 and that is configured to implement a sending function may be considered as a sending unit. That is, the transceiver 803 includes the receiving unit and the sending unit. The receiving unit sometimes may also be referred to as a receiver machine, a receiver, a receive circuit, or the like. The sending unit sometimes may also be referred to as a transmitter machine, a transmitter, a transmit circuit, or the like.

The processor 801, the memory 802, and the transceiver 803 communicate with each other by using an internal connection path, to transmit a control signal and/or a data signal.

The methods disclosed in the foregoing embodiments of the present invention may be applied to the processor 801, or implemented by the processor 801. The processor 801 may be an integrated circuit chip and has a signal processing capability. In an implementation process, steps in the foregoing methods may be completed by using an integrated logic circuit of hardware in the processor 801 or by using an instruction in a form of software.

A person skilled in the art may further understand that various illustrative logical blocks (illustrative logic block) and steps (step) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the protection scope of embodiments of this application.

It should be understood that the processor in embodiments of this application may be an integrated circuit chip, and has a signal processing capability. In an implementation process, steps in the foregoing method embodiments may be completed by using an integrated logic circuit of hardware in the processor or by using an instruction in a form of software. The processor may be a general-purpose processor, a digital signal processor (digital signal processor. DSP), an application-specific integrated circuit (application-specific integrated circuit, ASIC), a field programmable gate array (field programmable gate array, FPGA) or another programmable logic device, a discrete gate or a transistor logic device, a discrete hardware component, a system on chip (system on chip, SoC), a central processing unit (central processing unit, CPU), a network processor (network processor. NP), a digital signal processor (digital signal processor, DSP), a micro controller unit (micro controller unit, MCU), a programmable logic device (programmable logic device, PLD), or another integrated chip. The processor may implement or execute the methods, steps, and logical block diagrams disclosed in embodiments of this application. The general-purpose processor may be a microprocessor, or the processor may be any conventional processor or the like. Steps of the methods disclosed with reference to embodiments of this application may be directly executed and accomplished by using a hardware decoding processor, or may be executed and accomplished by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps of the foregoing method in combination with hardware of the processor.

The technologies described in this application may be implemented in various manners. For example, the technologies may be implemented by hardware, software, or a combination thereof. For hardware implementation, a processing unit configured to perform these technologies at a communication apparatus (for example, a base station, a terminal, a network entity, or a chip) may be implemented in one or more general-purpose processors, a DSP, a digital signal processor, an ASIC, a programmable logic device, an FPGA or another programmable logic apparatus, a discrete gate or transistor logic device, a discrete hardware component, or any combination thereof. The general-purpose processor may be a microprocessor. Optionally, the general-purpose processor may alternatively be any conventional processor, controller, microcontroller, or state machine. The processor may alternatively be implemented by a combination of computing apparatuses, such as a digital signal processor and a microprocessor, a plurality of microprocessors, one or more microprocessors in combination with a digital signal processor core, or any other similar configuration.

It may be understood that the memory in embodiments of this application may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM) that is used as an external cache. By way of example but not limitative description. RAMs in many forms may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory of the systems and methods described in this specification includes but is not limited to these and any other memories of appropriate types.

Optionally, in some embodiments, the memory 802 may store instructions used to perform the method performed by the terminal device in the methods shown in FIG. 5 and FIG. 8. The processor 801 may execute the instructions stored in the memory 802 to complete, in combination with other hardware (for example, the transceiver 803), the steps performed by the terminal device in the methods shown in FIG. 5 and FIG. 8. For a specific operation process and beneficial effects, refer to the descriptions in embodiments shown in FIG. 5 and FIG. 8.

An embodiment of this application further provides a chip, and the chip includes a transceiver unit and a processing unit. The transceiver unit may be an input/output circuit or a communication interface. The processing unit is a processor, a microprocessor, or an integrated circuit integrated on the chip. The chip may perform a method on the terminal device side in the foregoing method embodiments.

An embodiment of this application further provides a computer-readable storage medium. The computer-readable storage medium stores instructions, and when the instructions are executed, the method on the terminal device side in the foregoing method embodiments is performed.

An embodiment of this application further provides a computer program product including instructions. When the instructions are executed, the method on the terminal device side in the foregoing method embodiments is performed.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separate, and components displayed as units may or may not be physical units. To be specific, the components may be located at one position, or may be distributed on a plurality of network units. Some or all of the units may be selected according to actual requirements to achieve the objectives of the solutions in embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods according to embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-30. (canceled)

31. A communication method implemented by a terminal device, wherein the communication method comprises:
sending, to a network device, a user plane resource establishment request message;
receiving, from the network device in response to the user plane resource establishment request message, a feedback message comprising a received cause value of a user plane resource establishment failure;
performing a first operation when the received cause value is a first cause value; and
performing a second operation when the received cause value is a second cause value,
wherein the first cause value is different from the second cause value,
wherein the first operation is different from the second operation, and
wherein each of the first operation and the second operation establishes a communication link between the terminal device and the network device.

32. The communication method of claim 31, wherein the each of the first operation and second operation comprises at least one of:
updating a communication link route configuration;
re-sending, to the network device, the user plane resource establishment request message;
releasing a communication session resource and sending, to the network device, a session establishment request message;
sending, to the network device, a first deregistration request message to cancel registration with a first communications network and sending, to the network device, a first registration request message for the first communications network to establish the communication link using the first communications network;
enabling an offline mode and disabling the offline mode; and
sending, to the network device, a second deregistration request message to cancel registration with a third communications network and sending, to the network device, a second registration request message for a second communications network to establish the communication link using the second communications network.

33. The communication method of claim 32, further comprising:
setting a timer to time use of the second communications network; and
when the timer reaches a preset threshold:
sending, to the network device, a third deregistration request message to cancel registration with the second communications network; and
sending, to the network device, a third registration request message for the third communications network to establish the communication link using the third communications network.

34. The communication method of claim 33, wherein before the timer reaches the preset threshold, sending the second deregistration request message and sending the second registration request message, the communication method further comprises displaying a first identifier of the second communications network, and wherein after sending the third registration request message, sending the second deregistration request message and sending the second registration request message, the communication method further comprises displaying a second identifier of the third communications network.

35. The communication method of claim 32, further comprising sending, to the network device, information indicating that the terminal device does not support the third communications network.

36. The communication method of claim 31, wherein the first operation comprises K sub-operations, wherein the K sub-operations are in a one-to-one correspondence with K priorities, and wherein the communication method further comprises performing, based on the K priorities, the K sub-operations.

37. The communication method of claim 31, wherein the first operation comprises cyclically performing a target sub-operation M times, wherein the second operation comprises cyclically performing the target sub-operation N times, wherein both M and N are positive integers, and wherein M is not equal to N.

38. The communication method of claim 31, wherein the first cause value belongs to a first cause value type, wherein the first cause value type comprises one or more of a cause value #65, a cause value #67, a cause value #69, or a cause value #92, wherein the second cause value belongs to a second cause value type, and wherein the second cause value type comprises one or more of a cause value #95, a cause value #96, a cause value #97, a cause value #100, or a cause value #101; and
performing a first operation when the received cause value belongs to the first cause value type; and
performing a second operation when the received cause value belongs to the second cause value type.

39. A communication method implemented by a terminal device, wherein the communication method comprises:
determining that a communication link between the terminal device and a network device has failed;
updating a communication link route configuration; and
when the communication link still fails after updating the route configuration:
releasing a communication session resource;
sending, to the network device, a session establishment request message;
when the communication link still fails, sending, to the network device, a first deregistration request message to cancel registration with a first communications network;
sending, to the network device, a first registration request message for the first communications network to establish the communication link using the first communications network;
when the communication link still fails, sending, to the network device, a second deregistration request message to cancel registration with the first communications network; and
sending, to the network device, a second registration request message for a second communications network to establish the communication link using the second communications network.

40. The communication method of claim 39, further comprising:
setting a timer to time use of the second communications network; and
when the timer reaches a preset threshold:
sending, to the network device, a third deregistration request message to cancel registration with the second communications network; and
sending, to the network device, a third registration request message for the first communications network to establish the communication link using the first communications network.

41. The communication method of claim 40, wherein before the timer reaches the preset threshold, the communication method further comprises displaying a first identifier of the second communications network, and wherein after sending the third registration request message, the communication method further comprises displaying a second identifier of the first communications network.

42. The communication method of claim 39, further comprising sending, to the network device, information indicating that the terminal device does not support the first communications network.

43. The communication method of claim 39, wherein before releasing the session resource, the communication method further comprises sending, to the network device, a user plane resource establishment request message when the communication link has failed.

44. The communication method of claim 39, wherein before sending the second deregistration request message, the communication method further comprises enabling an offline mode and disabling the offline mode when the communication link has failed.

45. A terminal device comprising:
a transmitter configured to send, to a network device, a user plane resource establishment request message;
a receiver coupled to the transmitter and configured to receive, from the network device in response to the user plane resource establishment request message, a feedback message comprising a received cause value of a user plane resource establishment failure; and
a processor coupled to the transmitter and the receiver and configured to:
perform a first operation when the received cause value is a first cause value type; and
perform a second operation when the received cause value is a second cause value type,
wherein the first cause value type is different from the second cause value type,
wherein the first operation is different from the second operation, and
wherein each of the first operation and the second establishes a communication link between the terminal device and the network device.

46. The terminal device of claim 45, wherein each of the first operation and the second operation comprises at least one of:
updating a communication link route configuration;
re-sending, to the network device, the user plane resource establishment request message;
releasing a communication session resource and sending, to the network device, a session establishment request message;
sending, to the network device, a first deregistration request message to cancel registration with a first communications network and sending, to the network device, a first registration request message for a first communications network to establish the communication link using the first communications network;
enabling an offline mode and disabling the offline mode; and
sending, to the network device, a second deregistration request message to cancel registration with a third communications network and sending, to the network device, a second registration request message for a second communications network to establish the communication link using the second communications network.

47. The terminal device of claim 46, wherein the processor is further configured to set a timer to time use of the second communications network, and wherein the transmitter is further configured to:
send, to the network device when the timer reaches a preset threshold, a third deregistration request message to cancel registration with the second communications network; and
send, to the network device when the timer reaches the preset threshold, a third registration request message for the third communications network to establish the communication link using the third communications network.

48. The terminal device of claim 47, wherein the processor is further configured to:
display a first identifier of the second communications network before the timer reaches the preset threshold; and
display a second identifier of the third communications network after sending the third registration request message.

49. The terminal device of claim 46, wherein the transmitter is further configured to send, to the network device, information indicating that the terminal device does not support the third communications network.

50. The terminal device of claim 45, wherein the first operation comprises K sub-operations, wherein the K sub-operations are in a one-to-one correspondence with K priorities, and wherein the processor is further configured to perform, based on the K priorities, the K sub-operations.
